(19) United States
(12) Patent Application Publication
(10) Pub. No.: US 2004/0115322 A1
(43) Pub. Date: Jun. 17, 2004

(54) Animal carcass microbial reduction method

(76) Inventor: Matthew S. Osborn, Valley Center, KS (US)

Correspondence Address: DORSEY & WHITNEY LLP, INTELLECTUAL PROPERTY DEPARTMENT, 50 SOUTH SIXTH STREET, MINNEAPOLIS, MN, 55402-1498, US

(21) Appl. No.: 10/657,817

(22) Filed: Sep. 8, 2003

Related U.S. Application Data
(60) Provisional application No. 60/408,634, filed on Sep. 6, 2002.

(51) Int. Cl. A23K 1/00

(52) U.S. Cl. 426/326

(57) ABSTRACT

The present invention is a method of reducing microbial levels during meat production. The method includes applying an antimicrobial agent to the animal hide, before removal of the hide from the carcass. The method may further include rinsing and drying the animal hide.

### CROSS-REFERENCE TO RELATED APPLICATION(S)

This application claims priority to U.S. provisional patent application No. 60/408,634, filed Sep. 6, 2002, which is incorporated herein by reference in its entirety.

### FIELD OF THE INVENTION

The present invention relates to a hide-on carcass wash for reducing microbes during meat processing. More specifically, it relates to applying a fluid to an animal hide prior to removal to reduce microbes of the carcass. The present invention also relates to applying the fluid to the hide with wash flow and spraying systems.

### BACKGROUND

Concerns over surface pathogens on meat have been elevated in recent years due to E. coli related illnesses and deaths. In response, the USDA has imposed regulations and recommendations on food preparers to increase the likelihood that surface pathogens are killed prior to consumption. For example, restaurants must cook ground beef at 160° Fahrenheit throughout.

These end user regulations are an attempt to correct a problem that can begin during meat processing. During commercial meat production in a meat processing facility (i.e., a “slaughterhouse”), an animal (including, e.g., bovine, porcine, and ovine) carcass is subjected to a number of different procedures. For example, during commercial beef production, the following processes are typically performed. The animal is stunned and hung from a conveyor system, such as a trolley running along a rail. The animal is then exsanguinated by severing the arteries at the base of the neck. Next, the animal's hide is removed. Next, the carcass is subjected to a prewashing operation. Viscera is removed and the carcass is split into two halves. The carcass is then subjected to a steam pasteurization process to destroy microorganisms on the carcass. The carcass is weighed on a scale and washed. Finally, the carcass is chilled prior to being transported to the cut floor.

The removal of the animal's hide typically involves several steps, including making a series of cuts along a hide removal pattern. Initially, portions of the hide are typically partially removed by alternating manual and automated steps. The animal is then transported to a downpuller, which engages these partially removed portions of the hide and exerts a downward force on the hide thereby pulling the remainder of the hide from the animal's carcass.

This hide removal process can expose the carcass to materials resident on the hide, which may be transferred to the meat surfaces of the carcass. These materials may be transferred by either direct contact between the external surface of the hide and the meat surface of the carcass, by cutting instruments that puncture the hide and carry materials into the carcass, by dislodging of materials from the hide by the downpuller, or by carcass contact with instruments previously in contact with a hide. These materials on the hide may include microbes, such as E. coli, coliforms or other members of the Enterobacteriacea family.

There is a need in the art for an improved method of reducing microbial levels on an animal hide during meat production. There is a further need for a method of safely reducing microbial levels on the animal carcass.

### BRIEF SUMMARY OF THE INVENTION

The present invention, in one embodiment, is a method of reducing microbial level on the carcass of an animal. The method includes stunning the animal, applying a first antimicrobial agent to the animal hide, and reducing moisture from the hide.

Another embodiment of the present invention is a method of reducing a microbial level on an animal hide prior to removal of the hide from the carcass. The method includes providing an antimicrobial agent, and washing the hide with an antimicrobial agent, wherein the washing is performed at a pressure of between about 50 psi and about 2000 psi.

The present invention, in another embodiment, is a method of reducing microbial levels on a hide. The method includes spraying an animal hide with a first antimicrobial agent, rinsing the hide with a rinse fluid, drying the hide, removing the hide from the animal carcass, and placing the hide in a transport flume having a solution including an antimicrobial agent.

A further embodiment of the present invention is an apparatus for reducing a microbial level on an animal carcass prior to removal of the hide. The apparatus has a first wash chamber configured to allow for applying a first wash solution to the animal carcass and a second wash chamber configured to allow for applying a second wash solution to the animal carcass. The apparatus also has a first rail having at least one first shackle configured to attach to a first hind leg of the carcass and pull the carcass through the first and second wash chambers.

Another embodiment of the present invention is a re-circulating wash flow system. The system includes a tank configured to produce a recycled wash solution comprising used wash solution, a wash chamber configured to spray the recycled wash solution on a carcass, and a filter or series of filters configured to filter impurities from the used wash solution prior to the used wash solution flowing into the tank.

Another embodiment of the present invention is a hide-on carcass wash flow system having a re-circulating wash flow and a one-time wash flow. The re-circulating wash flow has a first tank configured to collect water, an antimicrobial agent and used wash solution to produce a first wash solution, a first wash chamber configured to spray the first wash solution on a carcass, and a filter configured to filter impurities from the first wash solution after being sprayed on the carcass and prior to the first wash solution flowing into the first tank. The one-time wash flow has a second tank configured to collect used water and an antimicrobial agent to produce a second wash solution, a filter or series of filters configured to filter impurities from the water prior to the water flowing into the second tank, and a second wash chamber configured to spray the second wash solution on the carcass.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a flow chart showing a method of reducing microbial levels on an animal hide, according to one embodiment of the present invention.

FIG. 2 is a plan view showing a pattern of incisions in a hide of a carcass.

FIG. 3A is a schematic diagram of a re-circulating wash flow system, according to one embodiment of the present invention.

FIG. 3B is a schematic diagram of a non-re-circulating wash flow system, according to one embodiment of the present invention.

FIG. 3C is a schematic diagram of combination wash flow system, according to one embodiment of the present invention.

FIG. 4 is a flow chart showing a method of operating a flow system, according to one embodiment of the present invention.

FIG. 5 is a flow chart showing a another method of operating a flow system, according to one embodiment of the present invention.

FIG. 6 is a side view of a wash cabinet according to one embodiment of the present invention.

FIG. 7 is a front view of an entrance door of a wash cabinet according to one embodiment of the present invention.

FIG. 8 is a front view of a wash cabinet according to one embodiment of the present invention.

FIGS. 9A and 9B are flow charts showing a method of operating a wash cabinet, according to one embodiment of the present invention.

### DETAILED DESCRIPTION

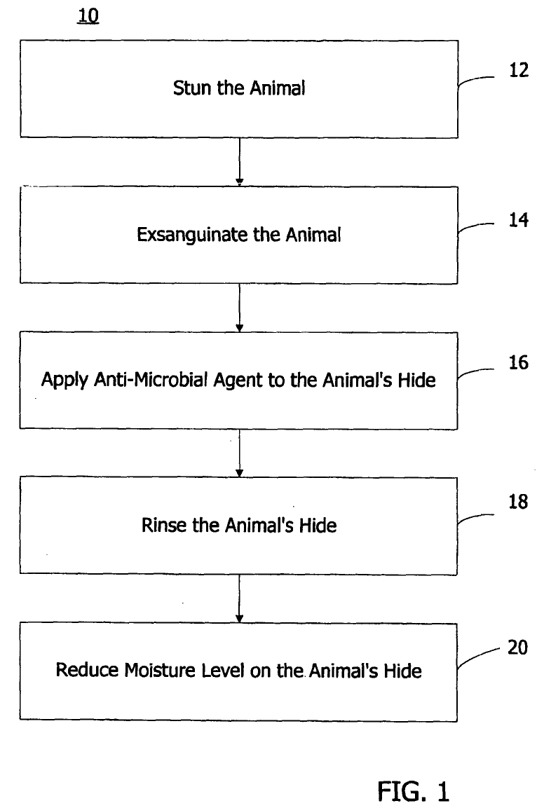

FIG. 1 is a flow chart showing a hide-on carcass wash method for reducing microbial levels 10 on an animal hide, during processing of the animal in a meat processing facility, according to one embodiment of the present invention. As shown in FIG. 1, the microbial reduction method 10, involves stunning the animal (block 12) and exsanguinating the animal (block 14), which causes clinical death of the animal. Next, an antimicrobial and/or loosening agent is applied to the animal hide (block 16). The hide then may he rinsed (block 18) and moisture on the hide may be reduced (block 20). One method for reducing moisture is vacuum drying. The microbial reduction method 10 can be used on any animal that is slaughtered and processed along a meat processing line, including cattle.

The present invention is applicable to all bovine, porcine, equine, caprine, ovine animals, or any other animal commonly slaughtered for food production. In this specification, bovine animals include, but are not limited to, buffalo and all cattle, including steers, heifers, cows, and bulls. Porcine animals include, but are not limited to feeder pigs and breeding pigs, including sows, gilts, barrows, and boars. Ovine animals include, but are not limited to, sheep, including ewes, rams, wethers, and lambs.

The stunning and exsanguination of the animal are performed using conventional techniques known in the art. In one embodiment, the application of the microbial agent is performed after stunning, but before exsanguination. The agent can be applied to the animal hide by any known technique. The agent according to one aspect of the invention is sprayed onto the animal hide, using a high pressure spray. In one embodiment the spray pressure is between about 50 and about 2,000 psi. In another embodiment the spray pressure is between about 500 and about 2,000 psi. In one embodiment, the spray pressure is about 900 psi. In another embodiment, the spray pressure is about 1700 psi. In various embodiments, the fluid is applied manually by an operator or it is applied by an apparatus, such as a spray cabinet. In one embodiment, the agent is applied to the animal hide using a contact washing technique, such as scrubbing or brushing. In one embodiment, a loosening agent is applied prior to stunning of the animal.

The antimicrobial agent may be any chemical or substance capable of killing, neutralizing, or removing microorganisms. In one embodiment, the antimicrobial agent is water or some combination of water and at least one other antimicrobial agent. The antimicrobial agent can be applied in a liquid, foam, or soap form. In a further alternative, the antimicrobial agent is one solute in a fluid solution or one component in a fluid mixture. In one embodiment, the agent is a surfactant or is applied in combination with a surfactant. In one embodiment, the method involves the use of a combination of two or more antimicrobial agents.

The agent applied to the animal hide can include any additive known to kill or remove bacteria or other kinds of microbes. For example, in one embodiment, the antimicrobial agent includes bases or caustics, acids, esters, oxidizers, or enzymes. Other examples include treated water, such as electrolytic water, ozonated water, or charged water, which includes hydrogen ions added to or removed from the water. In various embodiments, the antimicrobial agent includes one or more of sodium hydroxide, chlorine, trisodium phosphate, sodium metasilicate, phosphoric acid, fatty acid monoesters, organic acids, and hydrogen peroxide. In another aspect of the invention, the fluid is a probiotic agent. A probiotic agent is a non-harmful bacteria or other microbial that competitively prevents growth of microbial pathogens.

In some embodiments using sodium hydroxide as the antimicrobial agent, the sodium hydroxide is present in combination with water in an amount effective to reduce or eliminate microbe concentration. In one embodiment, the sodium hydroxide is present in an amount of between about 0.1 and about 5 percent by volume. In some embodiments using trisodium phosphate, chlorofoam (available from Birko Corporation), and Scalelite SR (a product containing phosphoric acid and hydrogen peroxide available from Birko Corporation), the substances are present in combination with water in an amount of between about 0.1 and about 5 percent by volume. In one embodiment, the substances are present in any amount effective to reduce or eliminate microbe concentration. In one embodiment, these substances are present in an amount of about 4 percent by volume.

In one embodiment of the present invention, the antimicrobial agent is one of sodium hydroxide, chlorofoam., or Scalelite SR, in the amounts set forth above, in a carrier, such as water, in combination with an acidified chlorine titrated with an acid, such as acetic acid, to a pH of about 6.5. In another embodiment, the antimicrobial agent is water in combination with an acidified chlorine titrated with an acid such as acetic acid to a pH of about 6.5. In various embodiments, the acidified chlorine is present in a concentration of from about 50 to about 600 ppm. In one embodiment, the acidified chlorine is present in a concentration of about 200 ppm.

Further additives can be included with the antimicrobial agent. Soil softening agents, for example, can be added to promote the washing of the animal hide. Any additives known to promote the reduction of microbial levels on the hide.

In the embodiment shown in FIG. 1, the microbial reduction method 10 also includes rinsing the animal hide (block 18). The hide can be rinsed with any fluid in any form known to provide a rinsing action. For example, the rinsing fluid can be any of the agents discussed above, including water, bases or caustics, acids, esters, oxidizers, enzymes, chlorine dioxide, cetylpiridinium chloride, or treated water. In various embodiments of the present invention, the rinsing fluid includes one or more of lactic acid, peroxyacetic plus octanoic acid, peroxyacetic acid, acetic acid, chlorine, acidified chlorine, acidified sodium chlorite, hydrogen peroxide, trisodium phosphate, and citric acid. In one embodiment, the rinsing step is performed using a high pressure spray of rinsing fluid. In another embodiment, rinsing fluid is poured over the hide. In one embodiment of the present invention, the rinsing step is not performed.

As further shown in the embodiment shown in FIG. 1, subsequent to washing and in some cases rinsing the animal hide, the microbial reduction method 10 may further include vacuum drying of the hide (block 20). The term “drying,” as used herein, means reducing the moisture level. It does not requires a complete removal of moisture. According to one embodiment, moisture is removed from the hide with a vacuum. The vacuum can be a steam vacuum, a hot water vacuum, a hot air vacuum, or any other vacuum known to remove moisture. In another embodiment, the animal hide is dried by blowing high pressure air over the hide. Alternatively, the animal hide is dried by blowing low pressure, high velocity air over the hide. Moisture on the animal hide can be removed by any method known to eliminate liquid. In one embodiment of the present invention, the drying of the animal hide is not performed.

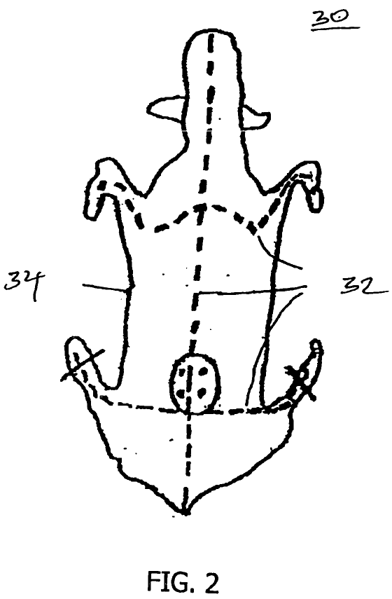

FIG. 2 depicts a typical “hide pattern” 30. The hide pattern 30 is created when cutting equipment is used to make incisions 32 in the hide 34 to facilitate the removal of the hide 34 from that carcass. Often the cutting equipment cuts though the animal hide 34 and leaves incisions in the carcass as well. The hide 34 can be pulled away from the carcass at these incisions 32. Such incisions 32 may be entry points for microbes. According to one embodiment of the invention, the process described above with reference to FIG. 1 is performed only along or in the general area of the hide pattern 30 or a portion of the hide pattern 30. In one embodiment, the animal hide is dried using a vacuum directed along the hide pattern 30.

According to another embodiment of the invention, an agent is applied, subsequent to the drying of the hide (block 20 in FIG. 1), along the incisions 12 to reduce microbial levels at the incisions 12. Alternatively, the agent is applied to the resulting carcass incisions 12 after the hide 14 has been removed. In a further alternative, the agent can be applied to both the incisions 12 in the hide 14 and carcass before the hide 14 is removed and the incisions 12 in the carcass after the hide 14 is removed. In one embodiment, this process is accomplished using a steam vacuum. In other words, a steam vacuum may be used to simultaneously apply an antimicrobial along the pattern and dry the hide along the pattern.

The agent applied to the incisions 12 can be any antimicrobial agents or additives as described above. For example, the agent might be iodine or some other antimicrobial additive known to kill microbes. Alternatively, the agent is water or some combination of water and at least one antimicrobial agent. In another aspect of the invention, the agent is a probiotic agent. A probiotic agent is a non-harmful bacteria or other microbial that competitively prevents growth of microbes. In one embodiment, the agent is cetylpiridinium chloride.

In another embodiment, the animal hide is treated with antimicrobial agent or agents during transportation to the hide treatment site. Typically, once the hide is removed from the carcass, the hide is dropped into a flume. A flume is a channel or chute carrying an antimicrobial agent according to the present invention. Once the animal hide is in the flume, it is transported by the stream of water to a subsequent treatment location. In one embodiment, the temperature of the antimicrobial agent is cooled prior to introduction into the flume is reduced to help preserve the hide by reducing bacteria growth. In one embodiment of the invention, the temperature of the water in the flume is reduced to below about 80° Fahrenheit. In one embodiment, the temperature is reduced to between about 40 and about 50° Fahrenheit. In one embodiment, the temperature is reduced to any temperature above the freezing point of the antimicrobial agent in the flume. In one embodiment, the temperature is reduced by directing the used water through a water chiller or plate water chiller, as known in the art. In one aspect of the invention, an antimicrobial agent (or agents) is placed in the stream of water in the flume and provides further antimicrobial action to the hide while it is in the flume water. The agent can be any of the agents other than water discussed above, including bases or caustics, acids, esters, oxidizers, or enzymes. Other examples include treated water.

In one embodiment, the antimicrobial agent is a solution including acetic acid, chlorine, and sodium hydroxide. In an alternative embodiment, waste liquid containing residual antimicrobial agent or agents from the washing or rinsing of the hide is directed to flow into the flume, providing flume water that provides an antimicrobial treatment to each hide as it is transported along the flume. Subjecting the hide to an antimicrobial agent, before further treatment or processing, results in a higher percentage of quality hides. It is believed that the application of this antimicrobial agent to the flume further reduced bacteria and helps to prevents microbial growth on the hide, resulting in a higher quality hide having a higher economic value.

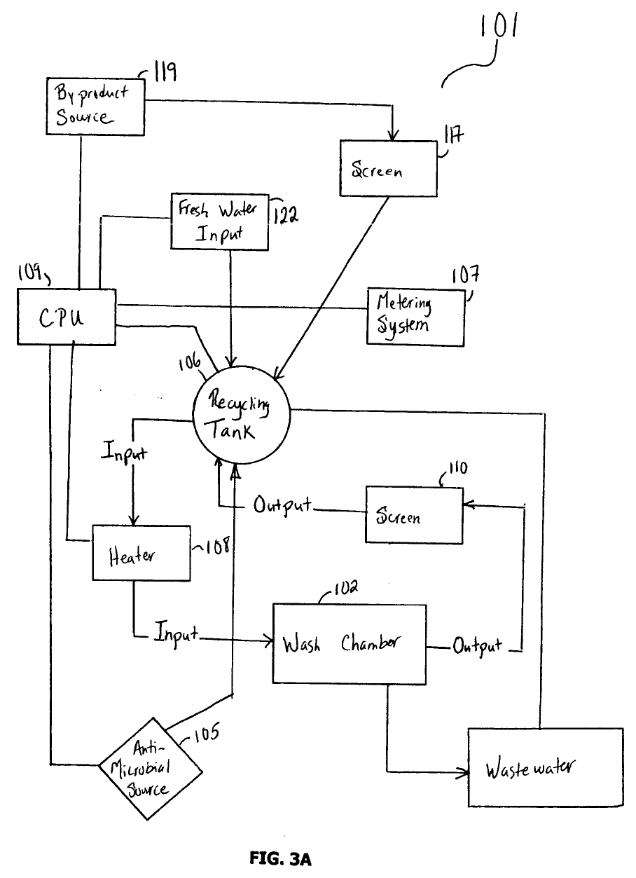

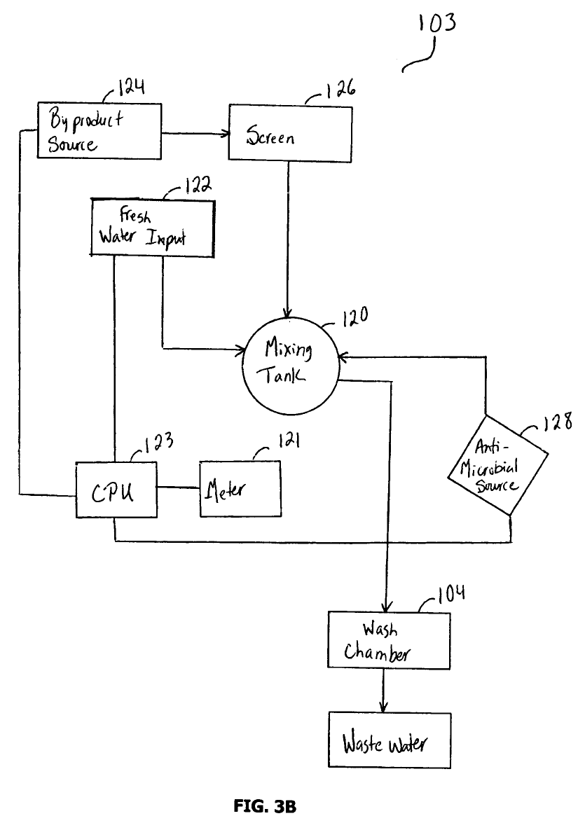

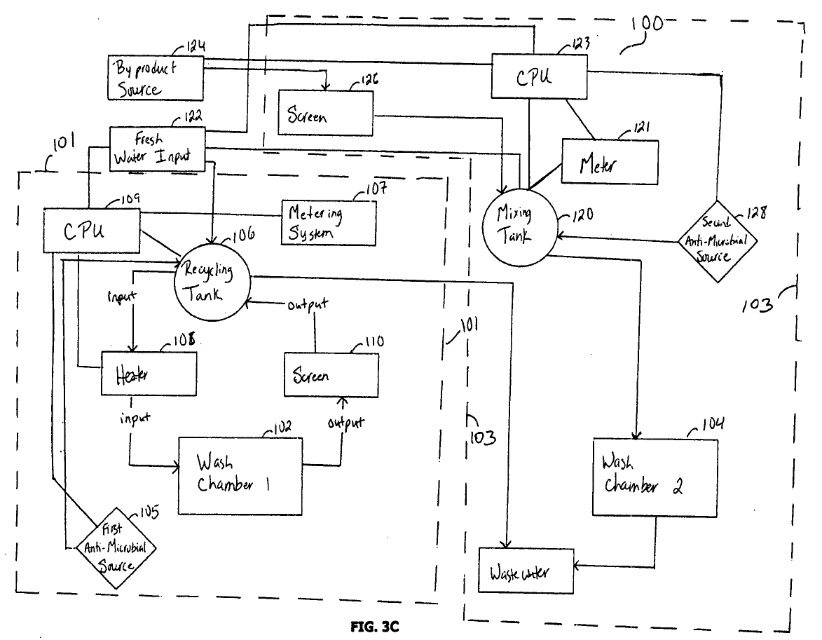

FIGS. 3A-3C show three exemplary embodiments of wash flow systems according to the present invention. FIG. 3A depicts a re-circulating wash flow system 101 according to one embodiment of the invention. The system 101 includes a recycling tank 106, a fresh water source 122, an antimicrobial source 105, and a wash chamber 102. The fresh water source 122 provides water to the recycling tank 106, while the antimicrobial source 105 provides antimicrobial agent to the recycling tank 106. The wash chamber 102 receives the wash solution from the recycling tank 106.

In accordance with one aspect of the invention, a byproduct source 119 may also provide liquid to the recycling tank 106. The byproduct source 119 provides byproduct liquid from a separate process to the recycling tank 106. The liquid from the byproduct source 119 according to one embodiment is waste antimicrobial solution from a different meat processing process. For example, the byproduct liquid may be run-off from the hide-on carcass wash. Alternatively, the byproduct liquid may be any run-off water from any known meat processing application or carcass wash. Known carcass washes include a pre-evisceration carcass wash, a head wash, offal washes, 180° Fahrenheit carcass wash, the post-inspection carcass wash, the post-evisceration carcass wash, the organic acid wash, and any chiller carcass wash. The byproduct liquid may contain any known combination of any known antimicrobial agents. In one embodiment, an additional amount of antimicrobial agent is added to the byproduct liquid.

According to a further embodiment of the present invention, the first flow system 101 has a separation device 117 between byproduct water source 119 and the recycling tank 106. The separation device 117 separates or filters unwanted particles out of the previously used byproduct liquid before the liquid enters the recycling tank 106. According to one embodiment, the separation device 117 is a screen 117. The screen 117 removes all particles larger than 0.02 inches in diameter. Alternatively, the separation device 117 is any device known to remove the smallest possible particles from a liquid. In a further embodiment, the separation device 117 is a cyclonic separator. Alternatively, the separation device 117 is an in-line filter or series of filters. In a further alternative, the separation device may be any combination of screens, cyclonic separators, and in-line filters. The separation device may also be any device known to remove unwanted particles from a solution.

According to one embodiment, the wash flow system 101 further includes a metering system 107 at the recycling tank 106. The metering system 107 maintains the proper level of antimicrobial agent in the wash solution by controlling the input of antimicrobial agent into the recycling tank 106 from the antimicrobial source 105.

The wash flow system 101 according to one aspect of the present invention also includes a heater 108 between the recycling tank 106 and the first wash chamber 102 for heating the water above ambient temperature. The heater 108 may heat the wash solution to a temperature ranging from about 100 to about 190° Fahrenheit. In a further embodiment, the heater 108 may heat the wash solution to a temperature ranging from about 140 to about 150° Fahrenheit. Alternatively, the heater 108 heats the wash solution to any temperature known to kill microbes. The heat applied to the wash solution performs two functions. First, it facilitates mixing of the chemicals in the wash solution. Second, it provides an additional antimicrobial element to the wash solution.

In accordance with a further embodiment of the present invention, the first flow system 101 has a separation device 110 between the first wash chamber 102 and the recycling tank 106. The separation device 110 separates or filters unwanted particles out of the used wash solution after the solution exits the first wash chamber 102. According to one embodiment, the separation device 110 is a screen 110. In one embodiment employing a screen 110, the screen 110 removes all particles larger than 0.02 inches in diameter. Alternatively, the separation device 110 is any device known to remove undesireable particles from a liquid. In a further embodiment, the separation device 110 is a cyclonic separator. In another embodiment, the separation device 110 is a centrifuge. Alternatively, the separation device 110 is an in-line filter or series of filters. In a further alternative, the separation device may be any combination of screens, cyclonic separators, centrifuges, and in-line filters. The separation device may also be any device known to remove unwanted particles from a solution.

In one embodiment of the present invention, the used wash solution is collected and tested for microbe levels. Based on these test results, the parameters of the wash chamber are adjusted to maximize microbe reduction. In one embodiment, for example, if microbe concentration remains above a certain level, the amount and/or temperature of the antimicrobial agent applied to the hide is increased. The used wash solution may then be retested to determine the impact of these changes on microbe levels in the used solution.

In a further embodiment of the present invention, a controller/processor unit (“CPU”) 109 is connected to the recycling tank 106, the fresh water source 122, the byproduct source 119, the antimicrobial source 105, the heater 108, and the metering system 107. The CPU operates to monitor and control the input of antimicrobial solution into the tank 106, by controlling the metering system 107. Further, the CPU may monitor and control the operation of the heater 108. The CPU may also monitor and control the fresh water input 122 or byproduct liquid source 119.

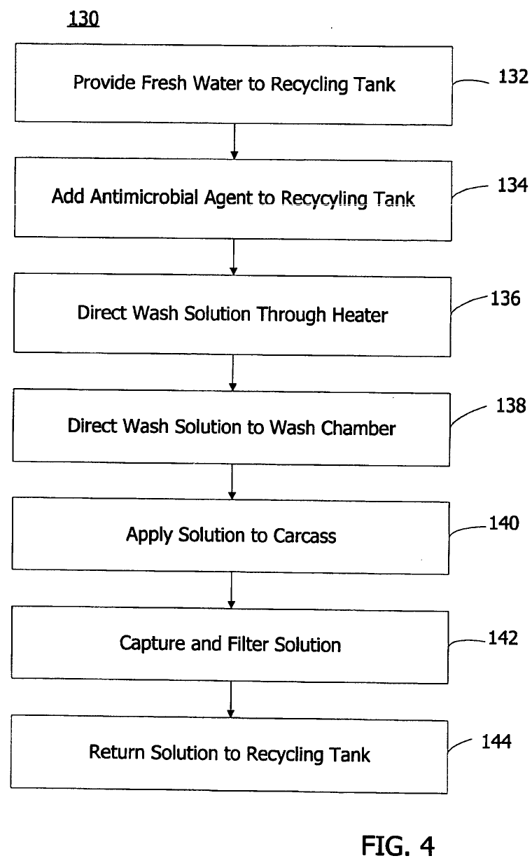

In operation, the wash flow system 101 continuously re-circulates, according to one embodiment of the present invention. A method 130 of operating the wash flow system is depicted in FIG. 4. As shown in FIG. 4, fresh water flows into the recycling tank (block 132), antimicrobial is added to the tank (block 134), the resulting wash solution is heated and directed to the wash chamber (blocks 136, 138), the solution is applied to the animal carcass (block 140), and the byproduct is captured and returned to the recycling tank (block 142, 144).

Fresh water flows from the fresh water source 122 to the recycling tank 106 at the beginning of operation (block 132). Alternatively, byproduct liquid from a separate meat processing application flows from the byproduct source 119, through a separation device 117, and to the recycling tank 106. This water is reused until the solution requires the addition of further fresh water or byproduct liquid as a result of loss of solution from the system. According to one embodiment, as wash solution is lost out of the system 101 due to evaporation, leakage, and other causes, additional water is added to the recycling tank 106 from the fresh water source 122 or the byproduct source 119.

In a further embodiment, the water flowing through the wash flow system 101 is replenished over a predetermined period according to one embodiment. That is, enough water is added from the fresh water source 122 or the byproduct source 119 to the recycling tank 106 over a set period of time to entirely replace the water re-circulating through the system 101. According to one embodiment, the water in the wash solution is entirely replenished by the fresh water source 122 or the byproduct source 119 every five hours. Alternatively, the water in the wash solution is entirely replenished from about every two hours to about every eight hours.

The antimicrobial agent is added in appropriate amounts to the recycling tank 106 (block 134). According to one embodiment, the addition of antimicrobial agent is controlled by the metering system 107, which maintains the appropriate level of antimicrobial agent in the solution. The metering system 107 in conjunction with the CPU 109 maintains sodium hydroxide at 1.5% according to one embodiment. Alternatively, any antimicrobial agent is maintained at any level as disclosed herein or known to have an antimicrobial effect on carcasses.

The wash solution flows from the recycling tank 106 through the heater 108 (block 136) according to one embodiment. The solution then flows to the wash chamber 102 (block 138), where the solution is sprayed on a carcass (block 140). When the solution flows out of the wash chamber 102, it may flow through a screen 110 (block 142) to remove unwanted particles before flowing back into the recycling tank 106 (block 144). Upon its return to the recycling tank, the solution has completed one loop of the continuous cycle of the wash flow system 101.

FIG. 3B depicts a non-re-circulating wash flow system 103 according to one embodiment of the present invention. The system 103 includes a fresh water source 122, a byproduct source 124, an antimicrobial source 128, a mixing tank 120, and a wash chamber 104. According to one embodiment, the system 103 further includes a metering system 121 at the mixing tank 120. The metering system 121 maintains the proper level of antimicrobial agent in the wash solution by controlling the input of antimicrobial agent into the mixing tank 120 from the antimicrobial source 128.

In accordance with a further embodiment of the present invention, the system 103 further includes a separation device 126 between the byproduct water source 124 and the mixing tank 120. The separation device 126 separates or filters unwanted particles out of the used byproduct liquid before the liquid enters the mixing tank 120. According to one embodiment, the separation device 126 is a screen 126. The screen 126 removes all particles larger than 0.02 inches in diameter. Alternatively, the separation device 126 is any device known to remove the smallest possible particles from a liquid. In a further embodiment, the separation device 126 is a cyclonic separator. Alternatively, the separation device 126 is an in-line filter or series of filters. In a further alternative, the separation device may be any combination of screens, cyclonic separators, and in-line filters. The separation device may also be any device known to remove unwanted particles from a solution.

In accordance with one aspect of the invention, a byproduct source 124 may also provide liquid to the mixing tank 120. The byproduct source 124 provides byproduct liquid from a separate process to the mixing tank 120. The liquid from the byproduct source 124 according to one embodiment is waste antimicrobial solution from a different meat processing process, such as carcass wash intervention downstream from the hide-on carcass wash. The byproduct liquid may contain any known combination of any known antimicrobial agents.

In a further embodiment of the present invention, a CPU 123 is connected to the mixing tank 120, the antimicrobial source 128, the metering system 121, the byproduct source 124, and the fresh water source 122. The CPU 123 operates to monitor and control the metering system 121, which controls the input of antimicrobial solution from the antimicrobial source 128 into the tank 120. The CPU may also monitor and control the input of fresh water from the fresh water source 122 and byproduct water from the byproduct source 124 into the tank 120.

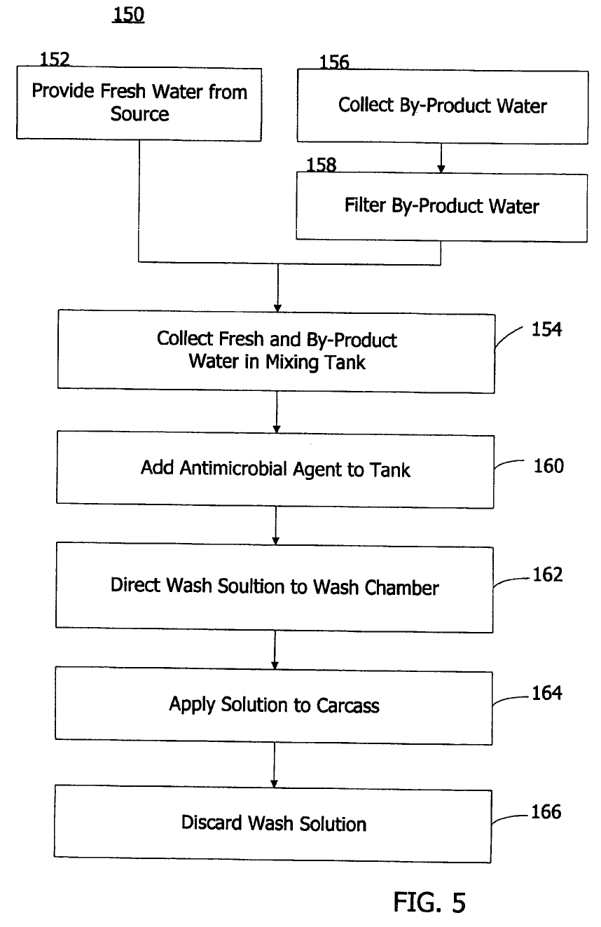

A method 150 of operating the non-re-circulating flow system 103, according to one embodiment, is depicted in FIG. 5. Fresh water flows from the fresh water source 122 (block 152). Alternatively, byproduct water flows as run-off from a separate process (block 156) and through a screen (block 158). Regardless of the source, the water flows into the mixing tank 120 (block 154).

At the mixing tank 120, an appropriate amount of antimicrobial additive is added to the mixing tank 120 from the antimicrobial source 128 (block 160). According to one embodiment, the antimicrobial additive is chlorine. The chlorine may be added to the mixing tank 120 at a rate of 30 parts per million. Alternatively, the chlorine is added such that after binding with organic compounds, there is from about 5 to about 500 parts per million free residual chlorine. In a further alternative, the antimicrobial additive is any antimicrobial agent known to reduce or eliminate microbes.

Next, the wash solution flows from the mixing tank 120 to the wash chamber 104 (block 162), where the solution is sprayed onto the carcass (block 164). According to one embodiment, after the solution is sprayed onto the carcass, the solution is then discarded (block 166). In accordance with one aspect of the invention, the solution is discarded by causing it to flow into a hide flume system as described herein.

FIG. 3C depicts a dual wash flow system 100 according to one aspect of the present invention. This system includes two independent wash flow systems: a re-circulating wash flow system 101 and a non-re-circulating wash flow system 103, each working concurrently to provide wash solution to separate wash chambers 102, 104. According to one embodiment, the re-circulating wash flow system 101 includes a recycling tank 106, a fresh water source 122, an antimicrobial source 105, and a first wash chamber 102, and operates as described above for the independent re-circulating system 101. According to one embodiment, the re-circulating wash flow system 101 further includes a metering system 107, a heater 108, a screen 110, and a CPU 109.

The non-re-circulating system 103, according to one embodiment, has a mixing tank 120, a fresh water source 122, a byproduct source 124, an antimicrobial source 128, and a second wash chamber 104, and operates as described above for the independent non-re-circulating system 103. According to one embodiment, the nor-re-circulating system 103 further includes a metering system 121, a screen 126, and a CPU 123.

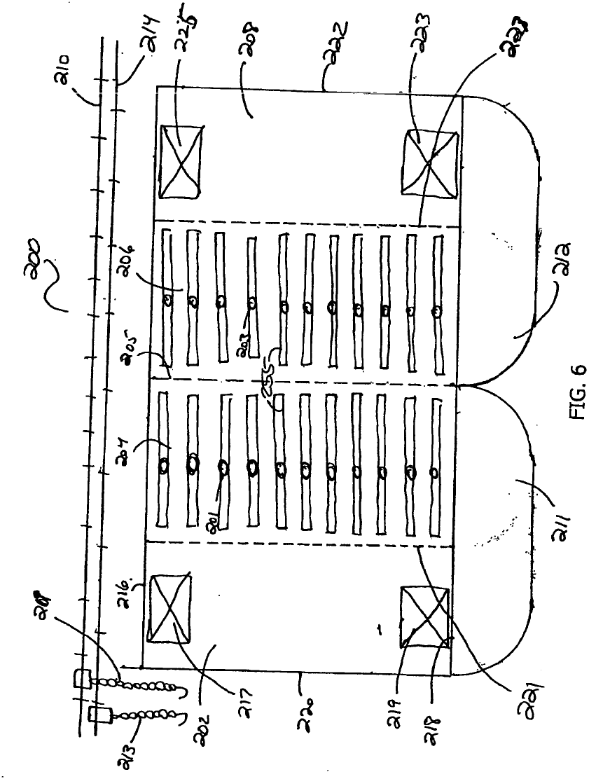

FIG. 6 depicts a side view of a wash cabinet 200 according to one embodiment of the present invention. The wash cabinet 200 may be used to wash animal carcasses. The wash cabinet 200 may operate in conjunction with any of the wash flow systems as shown in FIGS. 3A, 3B, or 3C. Alternatively, the wash cabinet 200 may operate in conjunction with any known wash flow system.

The wash cabinet 200 has a first wash chamber 204 and a second wash chamber 206. Alternatively, the wash cabinet 200 is actually a wash room 200 having a first wash area 204 and a second wash area 206. In one embodiment, the wash room is completely covered or separated from its surroundings to prevent escape of microbes.

In one embodiment, the first and second wash chambers 204, 206 are provided with wash solution by a wash flow system 100, 101, or 103 as described herein. In accordance with one aspect of the invention, the wash solution is applied by solution applicators or nozzles 201, 203 in each of the wash chambers 204, 206. The applicators 201, 203 are located along solution headers 255, which act as a manifold to supply solution to the nozzles. The solution headers 255 are coupled to a solution supply source. The wash cabinet also has a first buffer chamber 202 and a second buffer chamber 208 and a first drainage basin 211 and second drainage basin 212 beneath the floor 218 of the cabinet 200. According to one embodiment, the first buffer chamber 202 has an entrance door 220 and an inner entrance door 221, and the second buffer chamber 208 has an exit door 222 and an inner exit door 223. In one embodiment, the wash cabinet 200 has a first shackle rail 210 and a second shackle rail 214 above the wash chambers 204, 206. A first shackle 209 hangs from the first shackle rail 210 and a second shackle 213 hangs from the second shackle rail 214. In one embodiment, the first and second shackles 209, 213 hang from the same rail. In accordance with one aspect of the invention, the first and second buffer chambers 202, 208 have lower exhaust vents 219, 223 and upper exhaust vents 217, 225.

According to one embodiment, the shackles are chains with hooks. The shackles may be attached to a wheel that runs along a rail. Alternatively, the shackles are captive shackles that have no wheel, but rather are shackles connected directly to a drive chain associated with the rail. In a further alternative, the shackles are any known device for holding an animal carcass in a suspended position for movement through a meat processing application. According to one embodiment, one each of a first shackle 209, for use in shackling a first hind leg, and a second shackle 213, for use in shackling a second hind leg, are shackled to a carcass for transporting the carcass along the rails 210, 214 through the wash cabinet 200. This double shackle configuration maintains the orientation of the carcass as it moves through the wash cabinet 200

In accordance with one aspect of the invention, several first shackles 209 are provided to move along the first shackle rail 210 at predetermined intervals and several second shackles 213 are provided to move along the second shackle rail 214 at predetermined intervals. According to one embodiment, the space between each first shackle 209 along the first shackle rail 210 and the space between each second shackle 213 along the second shackle rail 214 is 4 feet. Alternatively, the space between the shackles 209, 213 can be anywhere from about two feet to about six feet. In one embodiment, the spacing between the each successive shackle 209, 213 is reduced from a spacing before and after the wash cabinet 200, along the meat processing line. A reduced spacing design, allows the shackles 209, 213 to be driven at a reduced speed within the wash cabinet 200, which can reduce movement of each carcass. The reduced travel speed also increases the residence time of each carcass within the wash cabinet 200, which allows increased time for reducing microbe level on the carcass.

In an alternative embodiment, the wash cabinet 200 has only one shackle rail 210 having shackles 9 hanging at predetermined intervals. Each shackle 9 can each be shackled to one hind leg of a carcass and assist in transporting the carcass along the rail 210 through the cabinet 200.

In one embodiment, the wash cabinet 200 includes a rub rail located near the entrance door 220. The rub rail is positioned to contact the carcass upon its entry into the wash cabinet 200 to effect its orientation. The rub rail operates to ensure that each carcass enters the wash cabinet 200 in a consistent and standard orientation, which allows consistent treatment of the carcass.

The first wash chamber 204 has first solution applicators 201, according to one embodiment of the present invention. In accordance with one aspect of the invention, there are around eleven applicators 201. In one embodiment, the number of applicators 201 in a solution header 255 varies depending on the location of the header. In one embodiment, for example, the solution headers 255 facing a front side of the carcass have a greater number of applicators 201 then the solution headers 255 facing a back side of the carcass. In another embodiment, for example, solution headers 255 located near the belly have a larger number of applicators 201. Alternatively, the number of applicators 201 varies between one applicator 201 and any number of applicators 201 known to provide a thorough wash to all portion of the carcass. According to one embodiment, the solution applicators 201 are spray headers with nozzles.

The nozzles can be configured in any number of ways depending on desired nozzle patterns and oscillation patterns. In one embodiment, the solution applicators 201 are any known apparatuses for applying or spraying a wash solution. The first solution applicators 201 may be elements of a continuously re-circulating wash flow system 101 as described herein. Alternatively, the wash solution provided to the first solution applicators 201 may be provided by any known system for providing liquid for spraying. The first solution applicators 201 apply wash solution inside the first wash chamber 204 at a pressure of about 900 psi. Alternatively, the first solution applicators 201 apply wash solution at a pressure of from about 50 psi to about 2,000 psi. The first solution applicators 201 may apply around 400 gallons of wash solution per minute. Alternatively, the first solution applicators 201 may apply from about 50 gallons to about 500 gallons of wash solution per minute.

In one embodiment, the headers 255 are mechanically coupled to an oscillator to effect oscillation of the solution applicators 201 located along each header. In one embodiment, all headers in each wash chamber are coupled to one another to accomplish synchronized oscillation of all applicators 201 in the chamber. In one embodiment, the applicators 201 oscillate between a first position generally perpendicular to a carcass and a second position about 60 degrees down from the first position. In another embodiment, the second position is from about 10 to about 80 degrees down from the first position. In one embodiment, the applicators 201 oscillate between any two positions that is effective in removing microbes and particles from the carcass.

The wash solution applied in the first wash chamber 204 according to one embodiment is a solution containing 1.5% sodium hydroxide by volume. Alternatively, the wash solution may contain from about 0.1 to about 5.0 percent sodium hydroxide by volume. In a further alternative, the wash solution is a solution containing any of the antimicrobial agents disclosed herein in any disclosed concentration. The wash solution in another alternative contains any known antimicrobial at any known concentration that is effective for providing antimicrobial action.

The first drainage basin 211 collects the wash solution after it has been sprayed from the solution applicators 201. The first drainage basin 211 is two feet in depth. Alternatively, the first drainage basin 211 is from about 1 foot to about 5 feet in depth. In a further alternative, the first drainage basin 211 is any depth known to prevent loss of wash solution out of the cabinet 200 by splashing or bouncing out of the basin 211 and escaping through the entrance of the cabinet 200. The first drainage basin 211, according to one embodiment, is connected to the continuously re-circulating wash flow system 101 such that it provides for flow back to the recycling tank 106. Alternatively, the first drainage basin 211 allows for removal of the wash solution from the wash cabinet 200 in any known fashion.

The second wash chamber 206 has second solution applicators 203, according to one embodiment of the present invention. In accordance with one aspect of the invention, there are around eleven applicators 203. Alternatively, the number of applicators 203 varies between one applicator 203 and any number of applicators 203 known to provide a thorough carcass wash. According to one embodiment, the solution applicators are spray headers with nozzles 203.

The nozzles can be configured in any number of ways depending on desired nozzle patterns and oscillation patterns. In a further alternative, the solution applicators 203 are any known apparatuses for applying or spraying a wash solution. The second solution applicators 203 may be elements of a non-re-circulating wash flow system 103 as described herein. Alternatively, the wash solution provided to the solution applicators 203 may be provided by any known system for providing liquid for spraying. The solution applicators 203 apply wash solution inside the second wash chamber 206 at a pressure of about 900 psi. Alternatively, the solution applicators 203 apply wash solution at a pressure of from about 50 to about 2000 psi. The solution applicators 203 apply 200 gallons of wash solution per minute. Alternatively, the solution applicators 203 apply from about 50 gallons to about 500 gallons of wash solution per minute.

The wash solution applied in the second wash chamber 206 according to one embodiment is a solution containing chlorine at a concentration of about 30 PPM. Alternatively, the wash solution contains chlorine at a concentration of about 5 to about 500 PPM. In another aspect of the present invention, acetic acid is added with the chlorine to create a more effective antimicrobial action. In a further alternative, the wash solution applied in the second wash chamber 206 contains any known antimicrobial at any known concentration that is effective for providing antimicrobial action, including any of the antimicrobial agents and combinations disclosed herein.

The second drainage basin 212 collects the wash solution after it has been sprayed from the solution applicators 203. The second drainage basin 212 is two feet in depth. Alternatively, the second drainage basin 212 is from about 1 foot to about 5 feet in depth. In a further alternative, the second drainage basin 212 is any depth known to prevent loss of wash solution out of the cabinet 200 by splashing or bouncing out of the basin 212 and escaping through the exit of the cabinet 200. The second drainage basin 212 allows for removal of the wash solution from the wash cabinet 200 in any known fashion.

The space 205 between the first wash chamber 204 and the second wash chamber 206 is about 6.5 feet. Alternatively, the space 205 is from zero feet to about 20 feet.

The first buffer chamber 202 acts as a buffer between the first wash chamber 204 and the external environment. The second buffer chamber 208 acts as a buffer between the second wash chamber 206 and the external environment. According to one embodiment, the first buffer chamber 202 and the second buffer chamber 208 reduce or prevent the loss of wash solution from the wash cabinet 200 to the external environment. The pressure with which the solution applicators 201, 203 in the wash chambers 204, 206 apply the wash solution can create amounts of spray and mist blowing around in the wash chambers 204, 206. The buffer chambers 202, 208 are provided to prevent the wash solution from escaping the wash chambers 204, 206 as a result of the strong amounts of energy created by the solution applicators 201, 203. According to one embodiment, the entrance door 220 and the inner entrance door 221 of the first buffer chamber 202 help to prevent escape of the wash solution. Further, the exit door 222 and the inner exit door 223 of the second buffer chamber 208 also reduce wash solution escape.

In an alternative embodiment, the wash cabinet 200 has blowers at the entrance and exit to the two wash chambers 204, 206 instead of doors. The blowers, according to one embodiment, provide a steady stream of wind at the entrance and exit to the wash chambers 204, 206 to knock down the wash solution that may be escaping the chambers 204, 206. In one embodiment, the blowers are fans.

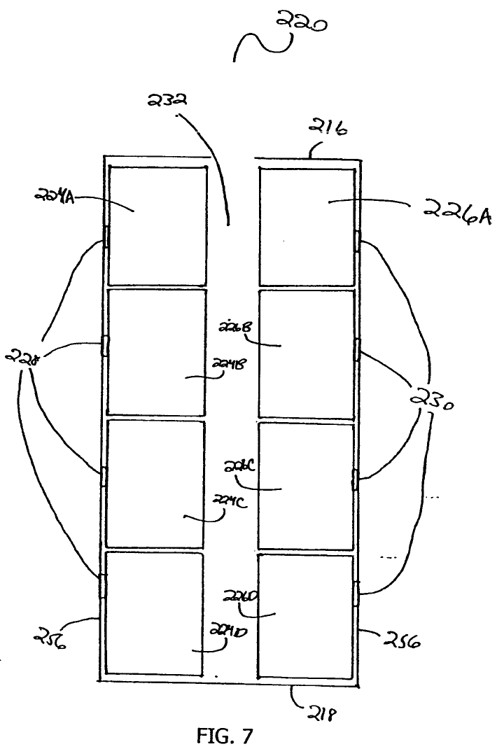

FIG. 7 depicts an entrance door 220 according to one embodiment of the present invention. Alternatively, the door 220 in FIG. 7 depicts an embodiment of an inner entrance door 221, an exit door 222, or an inner exit door 223. The entrance door 220 has a dual set of spring-loaded swinging doors: a first swinging door set 224A, 224B, 224C, 224D attached with hinges 228 to a wall 256 of the wash cabinet 200 and a second swinging door set 226A, 226B, 226C, 226D attached with hinges 230 to an opposite wall 257 of the wash cabinet 200. The first set is divided into four doors 224A, 224B, 224C, 224D, each being attached to a separate hinge 228 and each capable of swinging independently of the others. The second set is also divided into four doors 226A, 226B, 226C, 226D, each also attached to a separate hinge 230 and each capable of swinging independently of the others. The two door sets 224A, 224B, 224C, 224D, 226A, 226B, 226C, 226D have springs biasing the doors to remain in their closed positions. According to one embodiment, each of the first door set 224 and the second door set 226 are divided vertically into separate, independently swinging doors to maintain as much as possible a barrier to prevent the escape of wash solution. That is, the door sets are divided into separate doors to allow for only two of the four doors of a door set opening if the entering or exiting animal carcass is shaped accordingly. In this embodiment, the minimum amount of wash solution is allowed to escape.

In accordance with one aspect of the present invention, there is a space 232 between the first swinging door set 224A, 224B, 224C, 224D and the second swinging door set 226A, 226B, 226C, 226D. The space 232 may range in size from a very small distance between the door sets to about a distance that is equal to the girth of the smallest carcass that may pass through the cabinet 200. Alternatively, there is no space between the swinging door sets 224, 226. In a further alternative, the entrance door 220 is any door known to assist in preventing the escape of the wash solution from the wash cabinet 200. The inner entrance door 221, the exit door 222, and the inner exit door 223 may also be any door known to assist in preventing the escape of the wash solution from the wash cabinet 200.

Returning to FIG. 6, the first and second buffer chambers 202, 208 according to one embodiment are each five feet in length. Alternatively, the first and second buffer chambers 202, 208 are each three feet in length. In a further alternative, the first buffer chamber 202 is of a length that is sufficient to allow the carcasses to pass through the cabinet 200 such that both the entrance door 220 and the inner entrance door 221 are not open at the same time. In one embodiment, the second buffer chamber 208 is of a length that is sufficient to allow the carcasses to pass through the cabinet 200 such that both the exit door 222, and the inner exit door 223 are not open at the same time.

According to one embodiment, the exhaust vents 217, 219, 223, 225 are two feet tall and two feet wide. Alternatively, the exhaust vents 217, 219, 223, 225 are any known size for providing exhaust action to the wash cabinet 200. One or more of the exhaust vents 217, 219, 223, 225 can be closed off according to one aspect of the invention. For example, the lower exhaust vents 219, 223 can be closed while leaving the upper exhaust vents 217, 225 open to provide exhaust action at the top of the cabinet 200. According to one embodiment, the exhaust vents 217, 219, 223, 225 circulate air into the cabinet 200 at 60 cubic feet per minute. Alternatively, the vents 217, 219, 223, 225 circulate air at a rate of from about 20 cubic feet to about 80 cubic feet per minute.

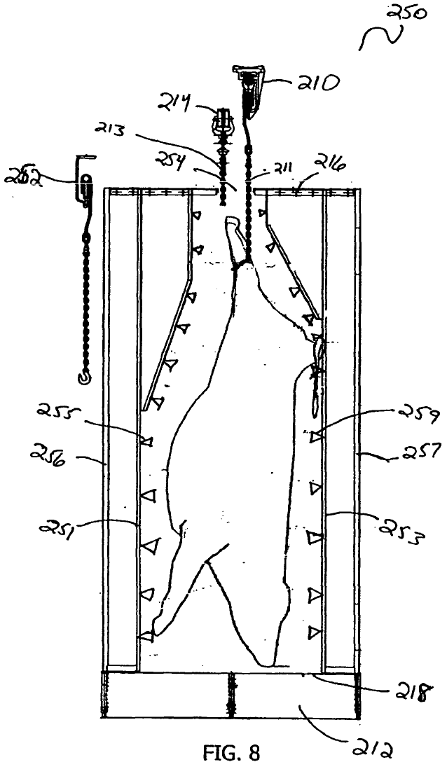

FIG. 8 depicts a front entrance view of a wash cabinet 250 according to one embodiment of the present invention in which the entrance door 220 is not depicted. The wash cabinet 250 has a first rail 210, a second rail 214, and a return rail 252. The cabinet 250 has a first outer wall 256, a second outer wall 257, a first inner wall 251, and a second inner wall 253. There are solution headers 255 on the first inner wall 251 and solution headers 259 on the second inner wall 253. The solution headers 255, 259 are configured to apply wash solution to a carcass through solution applicators or nozzles 201, 203 (shown in FIG. 6). In one embodiment, as shown in FIG. 8, the solution headers 255, 259 are spaced such that each wall 253, 256 includes from about 5 to about 15 solution headers 255, 259. In another embodiment, each chamber of the wash cabinet 250 includes from about 2 to about 25 solution headers 255, 259. In one embodiment, the solution headers are positioned such that they remain at a generally equal distance from the carcass.

The first shackle 209 hangs from the first rail 210 and is shackled to one hind leg of a carcass. The second shackle 213 hangs from the second rail 214 and is shackled to the other hind leg of the carcass. According to one embodiment, the first shackle 209 is attached to one hind leg and the second shackle 213 is attached to the other hind leg to ensure that the carcass does not rotate along an axis running the length of the carcass. That is, the first shackle 209 and second shackle 213 ensure that the carcass always faces the same direction while moving through the wash cabinet 250. In accordance with one aspect of the present invention, ensuring each carcass faces the same direction while moving through the wash cabinet 250 ensures that the wash solution sprayed from the solution headers 255 and 259 in each wash chamber 204, 206 is applied to critical areas. For example, preventing rotation according to one embodiment assures that wash solutions are applied to the carcass belly, where there is a strong possibility of microbes present where the cutting will occur.

According to one embodiment, both the first rail 210 and the second rail 214 are above and external to the wash cabinet 250. Where the rails 210, 214 are above the cabinet 250, the first shackle 209 and the second shackle 213 hang down from the rails 210, 214 through a space 254 in the ceiling 216 of the wash cabinet 250. A return rail 252 external to the cabinet 250 is provided for any second shackle 213 according to one aspect of the present invention. The first drainage basin 211 is depicted below the floor 218 of the wash cabinet 250.

In accordance with an alternative embodiment, blowers (not shown) are provided at the exit from the second buffer chamber 208. The blowers blow air over each carcass to remove moisture from the carcass. Alternatively, a mechanical drying apparatus is provided at the exit from the second buffer chamber 208. The mechanical drying apparatus mechanically removes moisture from each carcass by contacting the carcass in some manner. According to one embodiment, the mechanical drying apparatus is a brush system in which brushes are placed in contact with the carcass and brush the moisture off the carcass. Alternatively, the mechanical drying apparatus is a squeegee system in which the moisture is squeegeed off the carcass. In a further alternative, the mechanical drying apparatus involves spinning whips that knock the moisture off each carcass.

In an alternative embodiment, the wash system is a room, rather than a cabinet. Alternatively, the wash system is a dedicated area of a building. Like the wash cabinet herein, the wash room has a first wash area and a second wash area. Further, the wash room has a first shackle rail and a second shackle rail from which shackles hang that can be shackled to each carcass for transporting the carcass through the room. In addition, the wash room has a first drain associated with the first wash area and a second drain associated with the second wash area.

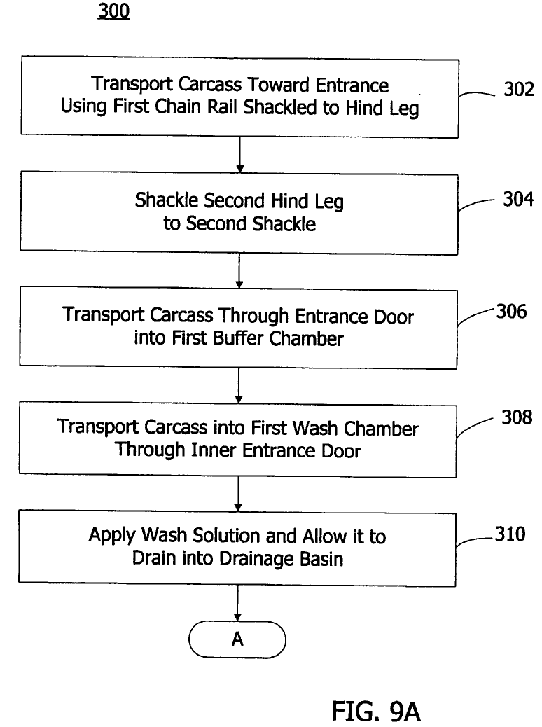

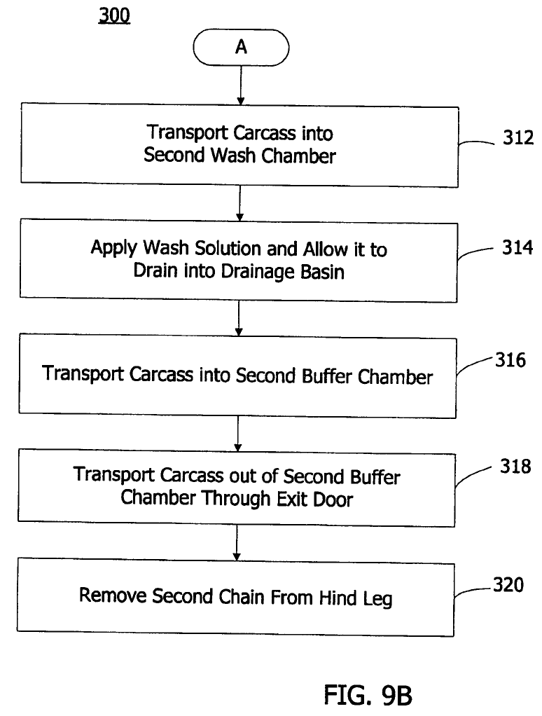

FIGS. 9A and 9B show a method 300 of operating the wash cabinet 200 according to one embodiment of the present invention. As shown in FIGS. 9A and 9B, a carcass is transported toward the entrance door 220 of the wash cabinet 200 along a first shackle rail 210 by a first shackle 209 that is shackled to a hind leg of the carcass (block 302). Prior to entering the first buffer chamber 202, the other hind leg is shackled with a second shackle 213 hanging from the second rail 214 (block 304). In one embodiment, the second shackle 213 is coupled to a chain, which rolls along a separate beam. The carcass is transported into the first buffer chamber 202 through the entrance door 220 (block 306). The carcass next is transported into the first wash chamber 204 through the inner entrance door 221 (block 308).

After the application of the wash solution to the carcass in the first wash chamber 204 and the sprayed wash solution is allowed to drain into the drainage basin 211 (block 310), the carcass is transported into the second wash chamber 206 (block 312). After application of the wash solution to the carcass in the second wash chamber 206 and the sprayed wash solution is allowed to drain into the drainage basin 212 (block 314), the carcass is transported through the inner exit door 223 into the second buffer chamber 208 (block 316). After the carcass is transported out of the second buffer chamber 208 through the exit door 222 (block 318), the second shackle is removed from the other hind leg of the carcass (block 320).

In one embodiment, the wash cabinet 200 is operated without the presence of any carcasses, to accomplish cleaning of the cabinet. In one embodiment, this cleaning of the wash cabinet 200 is performed between shifts or at other appropriate periods when the processing line is inoperative. Any of the antimicrobial agents discussed above can be used for washing of the wash cabinet 200. In one embodiment, for example, washing is performed using phosphoric acid or chlorine in combination with an acid.

Various aspects of the process of the invention can be altered to accomodate the condition of the animals to be treated. For example, during winter months cattle have longer coats and are generally dirtier. Therefore, aspects such as the composition of the antimicrobial agent, the temperature of the antimicrobial agent, pressure used in application of the antimicrobial agent, amount of the antimicrobial agent, time of treatment of the animal can be varied to take the condition of the animal into account.

The following example is presented by way of demonstration, and not limitation, of the invention.

### Example 1

Five embodiments of the method of reducing microbial levels are compared to examine (1) the differences in microbial reduction across various types of agents and (2) the differences in microbial reduction across various types of microbes.

Each animal hide in this example was obtained immediately after removal from a carcass and placed into a combo liner for transportation to the testing area. A combo liner is a bag designed to prevent any contamination of the hide during transportation to the testing area. Prior to testing, each hide was stretched over two fifty-gallon barrels placed end-to-end in a horizontal position to simulate an animal hide that has not been removed from the animal carcass.

Testing

Ten separate tests were performed on ten separate hides for each test sample. In each test, the hides were tested for the presence of three different microbes: enterobacteriacea, E. coli, and total coliforms. The various fluids tested for efficacy in microbial reduction on animal hides include: water, sodium hydroxide, chlorofoam, trisodium phosphate (“TSP”), Birko Scalelite SR, and various combinations of these components with acidified chlorine in varying concentrations.

The testing steps were the same for each test sample. First, a pre-test sponge sample was taken at three designated test locations on each hide: the head, the mid-section, and the tail. A sponge sample is a method of taking microbe samples involving a small sponge hydrated with a peptone solution so the bacteria obtained from the test location on the hide does not dehydrate. First, a sterile, plastic template providing for a 100 cm sampling area is placed on the target area of the hide. Second, the sample is taken by using the sponge to scrub the area ten times with a vertical motion, flipping the sponge over, and scrubbing the area ten times with a horizontal motion. The pre-test sample was taken to obtain an estimate of microbe levels in colony forming units per square centimeter (cfu/cm²) on the hide prior to treatment of the hide.

Second, each hide was sprayed at each of the three designated test locations with the designated agent, at a pressure of 1700 psi. Third, each hide was rinsed at each of the three test locations. For the method involving spraying with water, the test locations were rinsed with water, as well. For the other agents, the test locations were rinsed with a chlorine mixture. Fourth, a portion of each of the three test locations was dried using a steam vacuum without steam.

Fifth, a post-test washed sample was taken to obtain an estimate of the microbe levels in cfu/cm² at the portions of each of the three test locations that were washed. Further, a post-test washed and dried sample was taken to obtain an estimate of the microbial levels in cfu/cm² at the portions of each of the three test locations that were washed and dried.

Results

Spraying an animal hide with an agent and then rinsing the hide causes a reduction in each of the microbes on the hide. Additionally, drying the animal hide causes a further reduction in colony forming units (cfu). Table 1 shows the log of the average reduction in colony forming units of Enterobacteriacea per square centimeter resulting from applying certain substances to a hide, rinsing the hide, and then drying the hide. In Tables 1-3, the treatment identified as NaOH is 0.13% NaOH by volume in water and the treatments identified as Chlorofoam, TSP, and Scalite SR contain 4% by volume of each component in water.

TABLE 1
Enterobacteriacea

| TREATMENT | PRE-WASH | POST-RINSE | POST-DRY |
|---|---|---|---|
| Water | 4.69 | 3.34 | 2.85 |
| NaOH | 4.64 | 3.4 | 1.89 |
| Chlorofoam | 5.19 | 3.5 | 2.23 |
| TSP | 4.61 | 3.32 | 2.55 |
| Scalite SR | 4.78 | 2.56 | 1.75 |

Table 2 sets forth the log of the average reduction of E. coli in cfu/cm² resulting from the same process.

TABLE 2
E. Coli

| TREATMENT | PRE-WASH | POST-RINSE | POST-DRY |
|---|---|---|---|
| Water | 4.53 | 3.16 | 2.59 |
| NaOH | 4.35 | 3.14 | 1.28 |
| Chlorofoam | 5.19 | 3.34 | 2.09 |
| TSP | 4.5 | 3.17 | 2.39 |
| Scalite SR | 4.57 | 2.35 | 1.53 |

The effect of applying the same methods on the log of the average reduction of total coliforms in cfu/cm² are shown in Table 3.

TABLE 3
Total Coliforms

| TREATMENT | PRE-WASH | POST-RINSE | POST-DRY |
|---|---|---|---|
| Water | 4.63 | 3.27 | 2.75 |
| NaOH | 4.50 | 3.29 | 1.68 |
| Chlorofoam | 5.14 | 3.40 | 2.15 |
| TSP | 4.59 | 3.27 | 2.44 |
| Scalite SR | 4.69 | 2.46 | 1.72 |

As shown in Tables 1-3, each antimicrobial agent applied according to the present invention reduced hide microbial levels. For example, washing and rinsing the hide reduced the log of the average colony forming units of Enterobacteriacea by at least 1.24 for each agent tested. Further, the log of the average colony forming units of E. coli was reduced by at least 1.21. In addition, the log of the average colony forming units of total coliforms was reduced by at least 1.21. Similarly, the tables show further microbial reductions as a result of drying the hides.

The test procedure identified above was then used to test seven additional antimicrobial combinations. The log of the average colony forming units of Enterobacteriacea, E. coli, and total coliforms, for each antimicrobial are shown in Tables 4-6 below.

TABLE 4
Enterobacteriacea

| TREATMENT | PRE-WASH | POST-RINSE | POST-DRY |
|---|---|---|---|
| Water/Chl 100 | 4.73 | 2.58 | 2.03 |
| NaOH/Chl 200 | 5.03 | 2.54 | 1.71 |
| NaOH/Chl 500 | 4.58 | 2.31 | 1.26 |
| Chloro/Chl 200 | 4.70 | 2.77 | 1.75 |
| Chloro/Chl 500 | 4.69 | 1.87 | 1.03 |
| Scalite SR/Chl | 4.72 | 2.35 | 1.10 |
| 200 | | | |

TABLE 5
E. Coli

| TREATMENT | PRE-WASH | POST-RINSE | POST-DRY |
|---|---|---|---|
| Water/Chl 100 | 4.49 | 2.24 | 1.75 |
| NaOH/Chl 200 | 4.84 | 2.41 | 1.57 |
| NaOH/Chl 500 | 4.52 | 2.37 | 1.21 |
| Chloro/Chl 200 | 4.54 | 2.59 | 1.50 |
| Chloro/Chl 500 | 4.50 | 1.54 | 0.73 |
| Scalite SR/Chl | 4.60 | 2.21 | 0.78 |
| 200 | | | |

TABLE 6
Total Coliforms

| TREATMENT | PRE-WASH | POST-RINSE | POST-DRY |
|---|---|---|---|
| Water/Chl 100 | 4.68 | 2.51 | 1.96 |
| NaOH/Chl 200 | 4.92 | 2.49 | 1.65 |
| NaOH/Chl 500 | 4.65 | 2.47 | 1.34 |
| Chloro/Chl 200 | 4.67 | 2.68 | 1.65 |
| Chloro/Chl 500 | 4.64 | 1.70 | 0.59 |
| Scalite SR/Chl | 4.68 | 2.28 | 0.86 |
| 200 | | | |

As with the previous tests, Tables 4-6 show microbial reduction on animal hides for each of the antimicrobial agent combinations tested. The test procedure was then used to test an antimicrobial agent including 1.6% NaOH by volume in water, which was sprayed on the carcass at a pressure of 900 psi. The log of the average colony forming units of Enterobacteriacea, E. coli, and total coliforms, for this antimicrobial are shown in Table 7 below.

TABLE 7
NaOH Treatment

| MICROBE | PRE-WASH | POST-RINSE | POST-DRY |
|---|---|---|---|
| Enterobacteriacea | 5.08 | 0.44 | 0.39 |
| E. Coli | 4.90 | 0.11 | 0.31 |
| Total Coliforms | 5.05 | 0.31 | 0.11 |

As shown in Table 7, the sodium hydroxide solution also exhibited microbial reduction activity for each of the microbes sampled.

We claim:

1. A method of reducing microbial levels on the carcass of an animal during the slaughtering process, the method comprising:
stunning the animal; and
applying a first antimicrobial agent to at least a portion of the hide of the animal, subsequent to stunning and prior to removal of the hide.

2. The method of claim 1 further comprising, after the applying step, drying the hide, such that moisture is substantially removed from the surface of the hide

3. The method of claim 2 further comprising, after the stunning step, exsanguinating the animal to cause clinical death.

4. The method of claim 2 further comprising applying a second antimicrobial agents to the animal hide.

5. The method of claim 2 further comprising rinsing the animal hide.

6. The method of claim 5 further comprising applying a third antimicrobial agent after removing moisture from the animal hide, wherein the third antimicrobial agent is applied only to a hide incision pattern.

7. The method of claim 2 further comprising applying an additional amount of the first antimicrobial agent after removing the animal hide from a carcass, wherein the addition antimicrobial agent is applied only to incisions in the carcass along the hide pattern.

8. The method of claim 2 further comprising further applying a second antimicrobial agent after removing the animal hide from a carcass, wherein the second antimicrobial agent is applied only to incisions in the carcass along the hide pattern.

9. The method of claim 2 further comprising removing the hide from the animal and placing the hide in a transport flume.

10. The method of claim 9 further comprising collecting a waste liquid of the first antimicrobial agent and adding the waste portion to the transport flume.

11. The method of claim 2 wherein the first antimicrobial agent is about four percent sodium hydroxide by volume in water

12. The method of claim 11 wherein the antimicrobial agent is applied to the hide by spraying at a pressure of about 900 psi.

13. The method of claim 2 wherein the first antimicrobial agent includes a surfactant.

14. The method of claim 2 wherein the first antimicrobial agent includes a loosening agent.

15. The method of claim 2 wherein the first antimicrobial agent includes an additive chosen from the group consisting of: bases, acids, esters, oxidizers, enzymes, and treated water.

16. The method of claim 2 wherein the first antimicrobial agent includes an additive chosen from the group consisting of: sodium hydroxide, chlorine, trisodium phosphate, sodium metasilicate, phosphoric acid, fatty acid monoesters, organic acids, and hydrogen peroxide.

17. The method of claim 2 wherein the first antimicrobial agent includes fatty acid monoesters.

18. The method of claim 2 wherein the antimicrobial agent is selected from the group consisting of: sodium hydroxide, chlorofoam, Scalite SR, and trisodium phosphate.

19. The method of claim 2 wherein the spraying the animal hide is performed at a spray pressure of about 900 psi.

20. A method of reducing microbial levels on an animal prior to removal of an animal hide, the method comprising: stunning the animal;
providing an antimicrobial agent, subsequent to stunning and prior to removal of the hide; and
washing the animal hide with the antimicrobial agent, wherein the washing is performed at a pressure of between about 50 psi and about 2000 psi.

21. The method of claim 20 wherein the antimicrobial agent is water.

22. The method of claim 20 wherein the antimicrobial agent includes fatty acid monoesters.

23. The method of claim 20 wherein the antimicrobial agent includes sodium hydroxide.

24. The method of claim 20 wherein the antimicrobial agent is selected from the group consisting of: sodium hydroxide, chlorofoam, Scalite SR, and trisodium phosphate.

25. The method of claim 20 wherein the antimicrobial agent includes an additive chosen from the group consisting of: chlorine, trisodium phosphate, sodium metasilicate, phosphoric acid, fatty acid monoesters, organic acids, and hydrogen peroxide.

26. The method of claim 20 further comprising drying the animal hide.

27. A method of reducing microbial levels comprising:
spraying an animal hide with a first antimicrobial agent;
rinsing the animal hide with a rinse fluid;
drying the animal hide;
removing the animal hide from a carcass of the animal, after the drying step; and
placing the animal hide in a transport flume having a solution including an antimicrobial agent.

28. The method of claim 27 wherein the solution is a waste solution from antimicrobial treatment of the animal hide.

29. The method of claim 28 wherein the waste solution includes residual antimicrobial agent from spraying the animal hide.

30. The method of claim 27 wherein the first antimicrobial agent includes water.

31. The method of claim 27 wherein the rinse fluid includes water.

32. The method of claim 27 wherein the first antimicrobial agent is selected from the group consisting of: sodium hydroxide, chlorofoam, Scalite SR, and trisodium phosphate.

33. A method of reducing microbial levels on an animal hide, the method comprising:
removing the animal hide from a carcass; and
placing the animal hide in a transport flume including an antimicrobial agent.

34. The method of claim 33 wherein the antimicrobial agent is residual waste from a prior antimicrobial treatment of the animal hide.

35. The method of claim 33 wherein the antimicrobial agent includes chlorine.

36. The method of claim 33 wherein the antimicrobial agent is selected from the group consisting of: sodium hydroxide, chlorofoam, Scalite SR, and trisodium phosphate.

37. A carcass wash room comprising:
(a) a first wash chamber having a first solution applicator configured to apply a first wash solution to a hide of an animal carcass;
(b) a second chamber area having a second solution applicator configured to apply a second wash solution to the hide; and
(c) a first rail associated with the first and second wash areas having at least one first shackle hanging from the first rail, the at least one first shackle configured to attach to a first hind leg of the carcass and to carry the carcass through the first and second wash areas.

38. The apparatus of claim 37 further comprising a second rail associated with the first and second wash areas having at least one second shackle hanging from the second rail, the at least one second shackle configured to attach to a second hind leg of the carcass and to carry the carcass through the first and second wash areas.

39. The apparatus of claim 37 further comprising a first drainage area associated with the first wash chamber.

40. The apparatus of claim 39 further comprising a second drainage area associated with the second wash chamber.

41. The apparatus of claim 37 further comprising a first buffer chamber adjacent to the first wash chamber.

42. The apparatus of claim 41 further comprising a second buffer chamber adjacent to the second wash chamber.

43. The apparatus of claim 39 further comprising a second drainage basin associated with the second wash chamber.

44. The apparatus of claim 37 wherein the first wash solution is selected from the group consisting of: sodium hydroxide, chlorofoam, Scalite SR, and trisodium phosphate.
